(19) United States
(12) Patent Application Publication
(10) Pub. No.: US 2025/0135619 A1
(43) Pub. Date: May 1, 2025

(54) HAMMER BIT

(71) Applicant: Snap-on Incorporated, Kenosha, WI (US)

(72) Inventors: Craig Bashleben, Winthrop Hbr, IL (US); George R.R. Call, Kenosha, WI (US); Ottoleo Kuter-Arnebeck, Kenosha, WI (US); James T. Rettler, Kenosha, WI (US)

(73) Assignee: Snap-on Incorporated, Kenosha, WI (US)

(21) Appl. No.: 18/385,626

(22) Filed: Oct. 31, 2023

(51) Int. Cl. B25D 17/02; B25B 21/00; B25B 21/02

(52) U.S. Cl. CPC B25D 17/02; B25B 21/002; B25B 21/02; B25D 2250/051

(57) ABSTRACT

An air or impact hammer tool bit operatively coupled to a driver is described, whereby the axial force provided by the air or impact hammer is translated to an applied torque through a dedicated driver, such as a socket adapter or wrench. The air or impact hammer bit may include or define a receiving, or female, geometry to removably couple the dedicated driver. The bit may include additional anti-rotation geometry adapted to restrict the rotation of the bit while engaged with the air or impact hammer and retention geometry preventing the dedicated driver from disengaging from the bit.

### TECHNICAL FIELD OF THE INVENTION

The present invention relates generally to a driving tool, more particularly to an air or impact hammer bit adapted for use with a dedicated driver, such as a wrench, ratchet, or socket adapter.

### BACKGROUND OF THE INVENTION

Traditional methods of removing fasteners rely on static torque applied by a wrench, ratchet, or socket. In the case of stubborn or stuck fasteners, a breaker bar may be used to increase the leverage and torque applied to the fastener. Additionally, depending on the environment, the removal of stubborn or stuck fasteners, such as bolts, nuts, or the like, is difficult due the lack of clearance behind or around the head of the fastener.

Air hammers are known to provide a strong driving force to break, chisel, punch, strong materials, such as metal, concrete, or tile. Air or impact hammers, whether air powered or electrically powered (e.g., with a battery pack) may also be used to apply significant force, either axially or rotationally, to items such as nails, bolts, or the like. A motor drives a piston that actuates a chisel, punch, socket, or other attachment, to engage a workpiece with greater force than a tool actuated by hand only.

### SUMMARY OF THE INVENTION

The present invention relates broadly to a hammer tool bit, having female or male geometry, such as a slot, clevis, or the like, coupled to a driver, such as a wrench, socket adapter of the like. In an embodiment, the tool bit may include a square lug that is adapted to releasably couple with a bit or socket. When coupled to an air hammer, the force from the air hammer or impact hammer causes the impact from bit into the driver to provide torque to the fastener. According to an embodiment, a tool bit is described. The tool bit may include a shank having a distal end and a proximal end. The proximal end may be adapted to removably couple to a tool, such as an air hammer. The distal end may define an opening or coupling mechanism. A driver may be coupled to the shank through the opening or coupling mechanism, the driver comprising a driving structure. Actuating the shank along an axis of the shank may apply a linear force to the driving structure to generate a torque at the distal end connected to the work piece.

According to another embodiment, a bit for an air or impact hammer may include a shank having a distal end and a proximal end. The proximal end may be adapted to removably couple to the air hammer. The distal end defining a female geometry. A non-turning geometry may be disposed about the shank. A driver may be coupled to the female geometry of the distal end. The driver may include a driving structure. Actuating the shank along an axis of the shank may apply a force to the driving structure to generate a torque at the distal end connected to the work piece.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1A is a perspective view from above of an exemplar hammer bit and driver assembly, according to an embodiment of the present invention.

FIG. 1B is a perspective view from below of the hammer bit and driver assembly of FIG. 1A, according to an embodiment of the present invention.

FIG. 2A is a perspective view from above of another exemplar hammer bit and driver assembly, according to an embodiment of the present invention.

FIG. 2B is a side perspective view of the hammer bit and driver assembly of FIG. 2A, according to an embodiment of the present invention.

FIG. 3A is a frontside perspective view of another exemplar hammer bit and driver assembly, according to an embodiment of the present invention.

FIG. 3B is a rear side perspective view of the hammer bit and driver assembly of FIG. 3A, according to an embodiment of the present invention.

FIG. 4A is a perspective view of a disassembled another exemplar hammer bit and driver assembly, according to an embodiment of the present invention.

FIG. 4B is a perspective view of an assembled hammer bit and driver assembly of FIG. 4A, according to an embodiment of the present invention.

FIG. 5A is an exploded side perspective view of another exemplar hammer bit and driver assembly, according to an embodiment of the present invention.

FIG. 5B is a sectional side view of the hammer bit and driver assembly of FIG. 5A in an assembled form, according to an embodiment of the present invention.

FIG. 6A is an exploded side perspective view of another exemplar hammer bit and driver assembly, according to an embodiment of the present invention.

FIG. 6B is a sectional side view of the hammer bit and driver assembly of FIG. 6A in an assembled form, according to an embodiment of the present invention.

FIG. 7A is an exploded side perspective view of another exemplar hammer bit and driver assembly, according to an embodiment of the present invention.

FIG. 7B is a sectional side view of the hammer bit and driver assembly of FIG. 7A in an assembled form, according to an embodiment of the present invention.

FIG. 8A is an exploded side perspective view of another exemplar hammer bit and driver assembly, according to an embodiment of the present invention.

FIG. 8B is a sectional side view of the hammer bit and driver assembly of FIG. 8A in an assembled form, according to an embodiment of the present invention.

FIG. 9A is a side view of another exemplar hammer bit and driver assembly, according to an embodiment of the present invention.

FIG. 9B is a sectional side view of the hammer bit and driver assembly of FIG. 9A taken along B-B of FIG. 9A, according to an embodiment of the present invention.

FIG. 9C is another side view of the hammer bit and driver assembly of FIG. 9A in a second position, according to an embodiment of the present invention.

FIG. 9D is a sectional side view of a hammer bit and driver assembly of FIG. 9C taken along D-D of FIG. 9C, according to an embodiment of the present invention.

FIG. 9E is an exploded side view of the hammer bit and driver assembly of FIG. 9A, according to an embodiment of the present invention.

FIG. 10A is an exploded side perspective view of another exemplar hammer bit and driver assembly, according to an embodiment of the present invention.

FIG. 10B is a sectional side view of the hammer bit and driver assembly of FIG. 10A in an assembled form, according to an embodiment of the present invention.

### DETAILED DESCRIPTION

While the present invention is susceptible of embodiments in many different forms, there is shown in the drawings, and will herein be described in detail, embodiments of the invention, including a preferred embodiment, with the understanding that the present disclosure is to be considered as an exemplification of the principles of the present invention and is not intended to limit the broad aspect of the invention to any one or more embodiments illustrated herein. As used herein, the term “present invention” is not intended to limit the scope of the claimed invention but is instead used to discuss exemplary embodiments of the invention for explanatory purposes only.

The present invention relates broadly to a tool bit for a tool, such as an air hammer or impact hammer, that is adapted to be operatively coupled to a driver whereby the axial force provided by the air hammer or impact hammer is applied to the driving structure to generate a torque at the distal end connection, such as a socket adapter or wrench. According to an embodiment, the tool bit may include or define a coupling male, or female, geometry adapted to removably couple the dedicated driver. The bit may include additional anti-rotation geometry restricting rotation of the bit while engaged with the hammer, and retention geometry preventing the dedicated driver from disengaging from the bit.

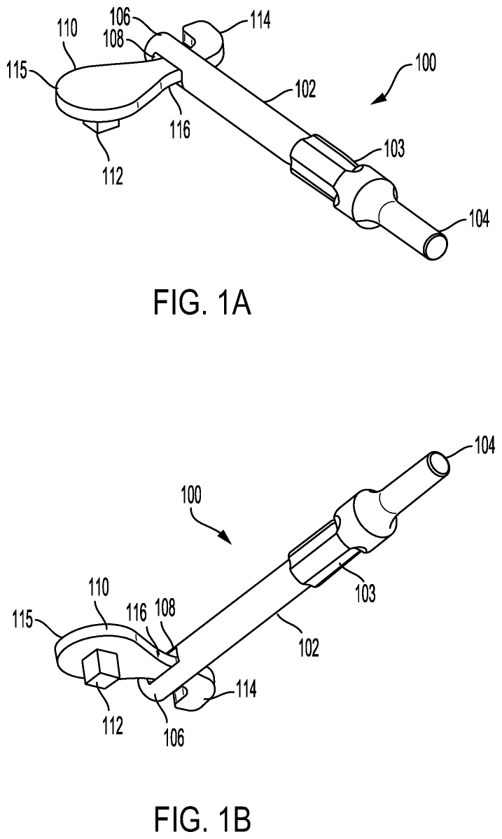

Referring to FIGS. 1A-1B, an embodiment of a hammer bit 100 may include or define a proximal end 104, a distal end 106 and a shank 102 coupling the proximal and distal ends. The proximal end 104 may be adapted to be received by, or otherwise coupled to, an air hammer or impact hammer (not shown) or other suitable tool. The bit 100 may also include or define a non-turning geometry portion 103 adapted to prevent unintended rotation of the bit 100 when engaged with the tool. The non-turning geometry 103 may include or define, for example, one or more flanges, bevels, edges, grooves, detents, or other surfaces about the outer circumference of the shank. The non-turning geometry 103 may abut or contact corresponding structures in the tool such that the bit 100 is restricted from rotating or spinning while engaged with the tool during use. The bit 100 may include or define a female geometry, such as a slot 108 defined or formed in the distal end 106 of the bit 100. The slot 108 may be adapted to couple with a driver.

According to an embodiment, the driver may include a geometry allowing the driver to couple with the bit 100 through a sliding engagement with the slot 108 of the distal end 106 of the bit 100. For example, the driver may be or include a socket adapter 110. The socket adapter 110 may include a first end 114 and second end 115 and a neck 116 disposed between the first and second ends. The first end may be curved about an axis of the socket adapter 110 at or near the neck 116 for the purpose of retaining the socket adapter 110 within slot 108. The second end 115 of the socket adapter 110 may include a male square lug 112 adapted to releasably coupled with a conventional socket (not shown) in a well-known manner. Alternatively, not shown, the embodiment may implement a female internal geometry to connect or to engage a work piece. The socket adapter 110 may be coupled to the bit 100 through a sliding and rotational engagement of the first end 114 through the slot 108 of the bit 100. The first end 114 of the socket adapter 110 may be curved such that to couple the socket adapter 110 to the bit, the first end 114 may be inserted through the slot 108 and rotated as the socket adapter 110 is further slid through the slot 108, whereby the neck 116 is disposed in or about the slot 108. The neck 116 and/or second end 115 may include a tapered width that increases as it approaches the second end 115 preventing the socket adapter 110 from sliding further through the slot 108. The curved first end 114 of the socket adapter 110 may prevent decoupling from the bit 100 if the socket adapter 110 moves in a substantially lateral or perpendicular direction to the axis of the bit 100.

During operation, when the tool, such as an air hammer or impact hammer, is actuated, the bit 100 may travel in an axial direction. The slot 108 of the bit 100 may engage the neck 116 of the socket adapter 110 causing the second end 115 and the square 112 to rotate. The impact of the bit 100 translates the axial force from the tool into an applied torque on the attached socket and fastener.

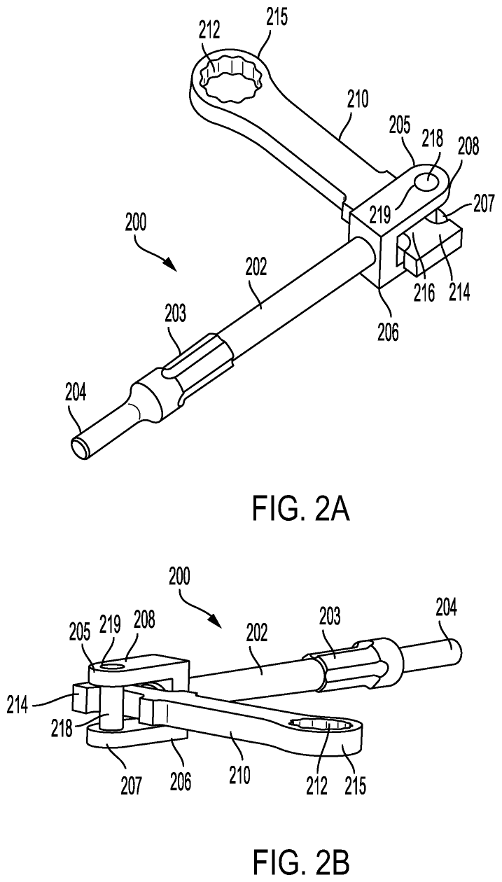

Referring to FIGS. 2A-2B, an embodiment of an air hammer or impact hammer bit 200 is depicted. Like the bit depicted in FIGS. 1A-1B, the bit 200 includes a proximal end 204, a distal end 206, and a shank 202 between the proximal and distal ends. The bit 200 includes a non-turning geometry portion 203 adapted to prevent undesired rotation of the bit 200 when engaged with the air or impact hammer.

According to an embodiment, bit 200 may include or define a female geometry, such as a clevis 208 or similar structure, that is adapted to retain a driver 210. The clevis 208 may include or define a first prong 205 and a second prong 207 defining a recess for receiving a first end 214 of the driver 210. A pin 218 may be disposed through pin recesses 219 respectively in the first prong 205 and the second prong 207. The driver 210 may include a second end 215 that may include a driving structure 212, such as a ratchet, wrench, or the like, adapted to be coupled to a fastener or other workpiece. The driver 210 may further define a reduced-width neck portion 216. The width of the neck portion 216 may be narrow enough to be disposed between the base of the clevis 208 and the pin 218 when the pin 218 is disposed between the first prong 205 and the second prong 207. The width of the first end 214 of the driver 210 may be wider than the distance between the base of the clevis 208 and the pin 218, such that once the driver is disposed substantially perpendicular to the shaft 202, between the first prong 205 and the second prong 207 and the pin 218 is in place, the driver is securely coupled to the clevis 208.

Actuating the bit 200 in an axial direction, with respect to the shaft 202, causes the driver 210 to rotate and provide a torque on the workpiece through the driving structure 212. The repeated actuation of the bit 200 by tool provides repeated applied force to the driver 210 resulting in an applied torque to the work piece.

According to an embodiment, the difference in the width of the neck portion 216 and the first end 214 may allow a user to selectively couple and uncouple the driver from the bit 200 by rotating and maneuvering the driver 210 to a significant angle relative to the shaft 202, whereby the first end may slide through space between the base of the clevis 206 and the pin 218.

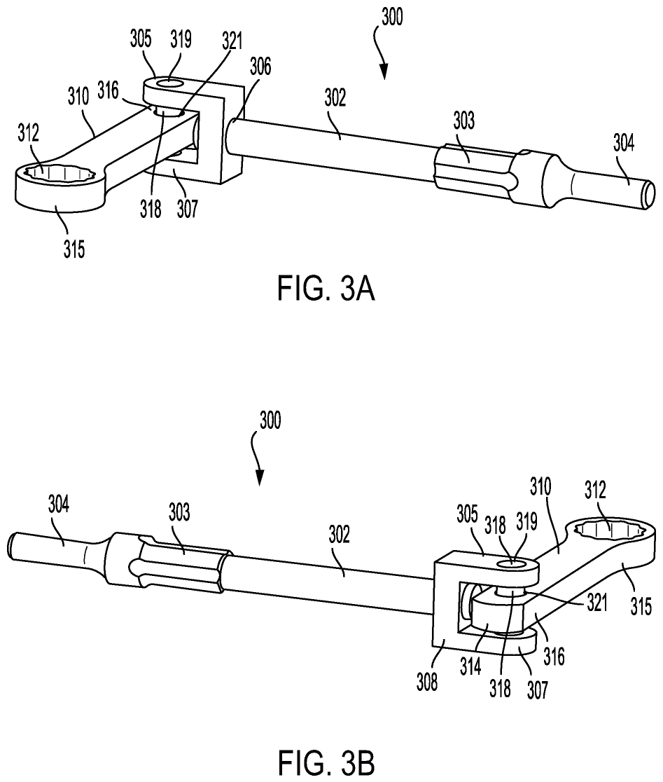

Referring to FIGS. 3A-3B, another embodiment of an air or impact hammer tool bit is depicted. Like the bit depicted in FIGS. 2A-2B, the bit 300 includes a proximal end 304, a distal end 306, and a shank 302 between the ends. The bit 300 includes a non-turning geometry portion 303 adapted to restrict undesired rotation of the bit 300 when engaged with the hammer.

According to an embodiment, the bit 300 may include or define a female geometry, such as a clevis 308 or similar structure to retain a driver 310. The clevis 308 may include or define a first prong 305 and a second prong 307 defining a recess for receiving a first end 314 of the driver 310. A pin 318 may be disposed through pin recesses 319 respectively in the first prong 305 and the second prong 307. The driver 310 may include a second end 315 that may include a driving structure 312, such as a ratchet, wrench, or the like, adapted to be coupled to a fastener or other workpiece. The driver 310 may further define a pin recess 321 in a neck portion 316 adapted to receive the pin 318, securing the driver 310 to the clevis 308.

Actuating the bit 300 in an axial direction, with respect to the shaft 302, causes the driver 310 to rotate and provide a torque on the workpiece through the driving structure 312. The repeated actuation of the bit 300 provides repeated applied force to the driver 310 resulting in an applied torque to the work piece.

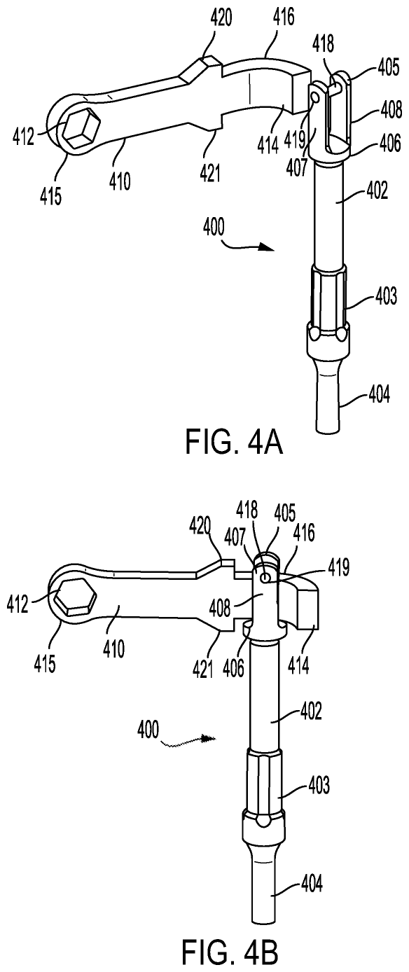

Referring to FIGS. 4A-4B, another embodiment of an air hammer or impact hammer tool bit is depicted. Like the bit depicted in FIGS. 3A-3B, the bit 400 includes a proximal end 404, a distal end 406, and a shank 402 between the ends. The bit 400 includes a non-turning geometry portion 403 adapted to restrict undesired rotation of the bit 400 when engaged with the hammer.

According to one embodiment, the bit 400 may include or define a female geometry, such as a clevis 408 or similar structure to retain a driver 410. The clevis 408 may include or define a first prong 405 and a second prong 407 defining a recess for receiving a first end 414 of the driver 410. A pin 418 may be disposed through pin recesses 419 respectively in the first prong 405 and the second prong 407. The driver 410 may include a second end 415 that may include a driving structure 412, such as a ratchet, wrench, or the like, adapted to be coupled to a fastener or other workpiece.

The driver 410 may further define or include a curved a neck portion 416 adapted to be received in the clevis 408. The driver 410 may be coupled to the bit 400 by inserting the first end 414 into the recess defined between the pin 418 and the first prong 405 and second prong 407 of the clevis 408. As the first end 414 of the driver 410 is inserted into the clevis, it may be rotated about the curved neck portion 416. The driver 410 may include or define first and second shoulders 420, 421, or similar protrusions extending from the body. The shoulders 420, 421 may be adapted to form a stop preventing the driver 410 from passing through the clevis 408. The curve of the neck portion 416 of the driver 410, once the driver 410 is coupled to the clevis 408, provided a stop such that once the driver 410 is disposed substantially perpendicular to the shaft 402, between the first prong 405 and the second prong 407, the driver 410 is securely coupled to the clevis 408. The driver 410 may be removed by reversing the rotation of the curved neck portion 416 and drawing the first end 414 from the clevis 408.

Actuating the bit 400 in an axial direction, with respect to the shaft 402, causes the driver 410 to rotate and provide a torque on the workpiece through the driving structure 412. The repeated actuation of the bit 400 provides repeated applied force to the driver 410 resulting in an applied torque to the work piece.

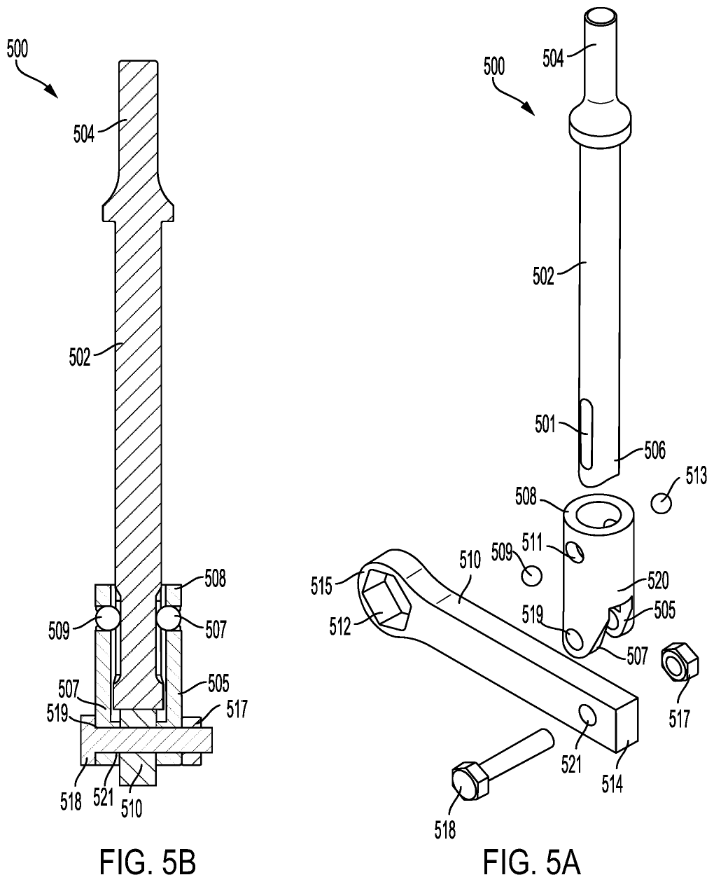

Referring to FIGS. 5A-5B, another embodiment of an air or impact hammer tool bit is depicted. Like the bit depicted in FIGS. 4A-4B, the bit 500 includes a proximal end 504, a distal end 506, and a shank 502 between the ends. The bit 500 may include a non-turning geometry portion (not shown) adapted to restrict undesired rotation of the bit 500 when engaged with the hammer tool, similarly to that shown in FIGS. 1A-4B.

According to an embodiment, the distal end 506 may include a groove 501 or slot or other similar structure. A sleeve 508 may be coupled to the distal end 506. According to an embodiment, the sleeve 508 may include or define a female geometry, such as a clevis 520 or similar structure, to retain a driver 510, including a first prong 505 and a second prong 507. Both the first prong 505 and the second prong 507 may each define a bolt recess 519. The sleeve 508 may further define one or more ball recesses 511. According to an embodiment, the sleeve 508 may be coupled to the distal end 506 by one or more balls 509, 513 respectively disposed in the ball recesses 511 and the groove 501. The balls 509, 513 may be ball bearings or similar structures. According to an embodiment, the balls 509, 513 may be respectively retained in the ball recesses 511 by embossing the sleeve 508 around the balls 519, 513 to crimp them in place. The balls 509, 513 may be adapted to allow the sleeve 508 to slide axially with respect to the shaft 502 the length of the groove 501.

The clevis 520 may be adapted to couple the driver 510 to the sleeve 508. The clevis 520 may receive a first end 514 of the driver 510. The first end 514 of the driver may include or define a driver recess 521 through which a bolt 518, or other similar fastener, may be disposed. The bolt 518 may extend through the bolt recesses 519 in the first prong 505, the driver recess 521 and the second prong 507. The bolt 518 may be secured to the clevis 520 of the sleeve 508 by a nut 517, or similar fastener. The driver 510 may pivot about the bolt 518, as described below. The bit 500 may impact the driver 510 on either face, allowing the user to flip the driver 510 as needed to access a fastener.

The driver 510 may include a second end 515 that may include a driving structure 512, such as a ratchet, wrench, or the like, adapted to be coupled to a fastener or other workpiece. Actuating the bit 500 in an axial direction, with respect to the shaft 502, causes the driver 510 to pivot about the bolt 518 and provide a torque on the work piece through the driving structure 512. The repeated actuation of the bit 500 by a hammer tool provides repeated applied force to the driver 510 resulting in an applied torque to the work piece.

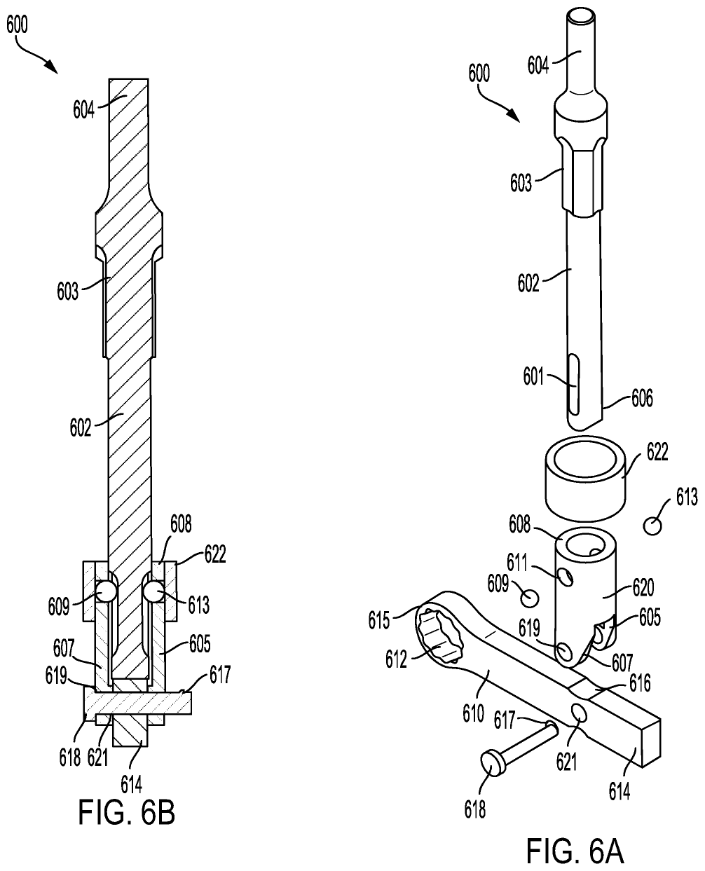

Referring to FIGS. 6A-6B, another embodiment of an air hammer or impact hammer tool bit is depicted. Like the bit depicted in FIGS. 5A-5B, the bit 600 includes a proximal end 604, a distal end 606, and a shank 602 between the ends. The bit 600 may include a non-turning geometry portion 603 adapted to restrict undesired rotation of the bit 600 when engaged with the air hammer, similarly to that shown in FIGS. 1A-4B.

According to an embodiment, the distal end 606 may include a groove 601 or slot or other similar structure. A sleeve 608 may be coupled to the distal end 606. The sleeve 608 may include or define a female geometry, such as a clevis 620 or similar structure, to retain a driver 610, including a first prong 605 and a second prong 607. Both the first prong 605 and the second prong 607 may each define a bolt recess 619. The sleeve 608 may further define one or more ball recesses 611. According to an embodiment, the sleeve 608 may be coupled to the distal end 606 by one or more balls 609, 613 respectively disposed in the ball recesses 611 and the groove 601. The balls 609, 613 may be ball bearings or similar structures. The balls 609, 613 may be adapted to allow the sleeve 608 to slide axially with respect to the shaft 602 the length of the groove 601. According to an embodiment, a collar 622 may be disposed over the coupling of the sleeve 608 and distal end 606. The collar 622 may be adapted to protect and secure the balls 609, 613 in the groove 601 and ball recesses 611. The collar 622 may be permanently or removably coupled to the sleeve 608 through a threaded connection, press-fit, welding, or other coupling structure.

The clevis 620 may be adapted to couple the driver 610 to the sleeve 608. The clevis 620 may receive a first end 614 of the driver 610. The first end 614 of the driver may include or define a driver recess 621 through which a pin 618, or other similar fastener, may be disposed. The pin 618 may extend through the pin recesses 619 in the first prong 605, the driver recess 621 and the second prong 607. The pin 618 may be secured to the clevis 620 of the sleeve 608 by a projection or other retaining structure included in or defined by the pin 618. The projection 617 may be sized and shaped to allow the pin 618 and projection 617 to be pushed through the pin recesses 619 and driver recess 621 with an applied force. The projection 617 may retain the pin 618 in place until such applied force is applied in reverse to draw the pin 618 from the clevis 620 and driver 610.

The driver 610 may include a second end 615 that may include a driving structure 612, such as a ratchet, wrench, or the like, adapted to be coupled to a fastener or other workpiece. Actuating the bit 600 in an axial direction, with respect to the shaft 602, causes the driver 610 to provide a torque on the work piece through the driving structure 612. The repeated actuation of the bit 600 by an air or impact hammer tool provides repeated applied force to the driver 610 resulting in an applied torque to the work piece. According to an embodiment, the distal end 606 of the bit 600 may include or define a curve adapted to impact a notch 616 of the driver 610. The notch 616 may include or define a corresponding curve adapted to receive the curved distal end 606. The notch 616 and the curved distal end 606 may facilitate smooth actuation while the driver 610 rotates to loosen the fastener. According to an embodiment, the driver 610 may include or define a notch 616 on opposing sides of the driver 610 body, allowing the driver 610 to rotated to a second orientation by rotating the driver 610 about the pin 618, or decoupling the driver 610, rotating to the new orientation and reinstalling the pin 618.

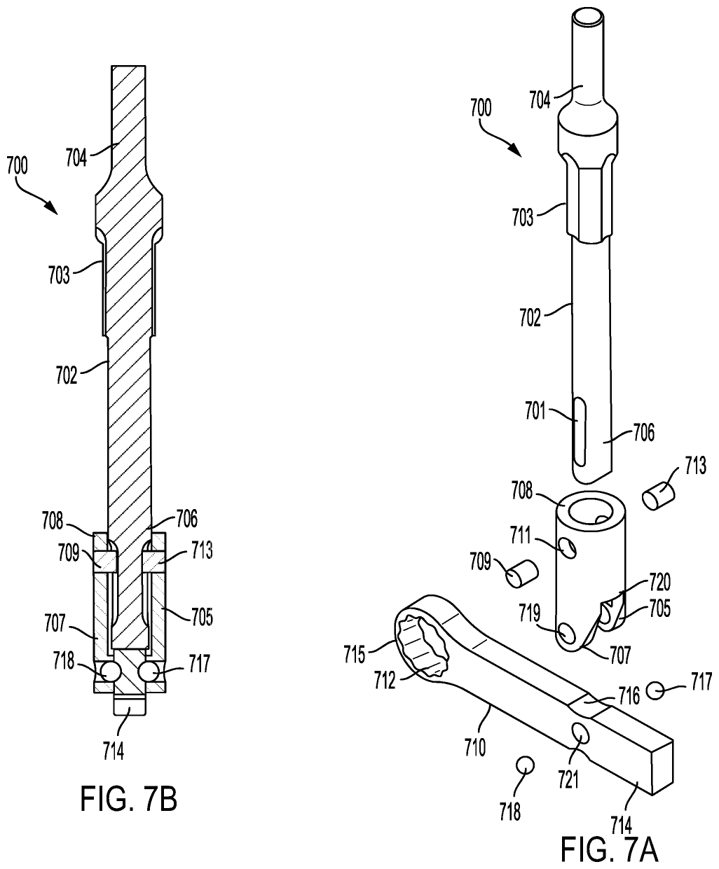

Referring to FIGS. 7A-7B, another embodiment of an air hammer or impact hammer tool bit is depicted. The bit 700 includes a proximal end 704, a distal end 706, and a shank 702 between the ends. The bit 700 may include a non-turning geometry portion 703 adapted to restrict undesired rotation of the bit 700 when engaged with the air hammer, similarly to that shown in FIGS. 1A-4B.

According to an embodiment, the distal end 706 may include a groove 701 or slot or other similar structure. A sleeve 708 may be coupled to the distal end 706. The sleeve 708 may include or define a female geometry, such as a clevis 720 or similar structure, to retain a driver 710, including a first prong 705 and a second prong 707. Both the first prong 705 and the second prong 707 may each define a ball recess 719. The sleeve 708 may further define one or more peg recesses 711. According to an embodiment, the sleeve 708 may be coupled to the distal end 706 by one or more pegs 709, 713 respectively disposed in the peg recesses 711 and the groove 701. The pegs 709, 713 may be adapted to allow the sleeve 708 to slide axially with respect to the shaft 702 the length of the groove 701. The pegs 709, 713 may be retained in sleeve 708 by method of press fit, embossment, weldment, or any other suitable method. Alternatively, a sleeve similar to sleeve 608 may be used to retain the pins.

The clevis 720 may be adapted to couple the driver 710 to the sleeve 708. The clevis 720 may receive a notch 716, divot or other indentation, defined in the first end 714 of the driver 710. The first end 714 of the driver may include or define a driver recess 721 through which one or more balls 717, 718, or other similar fastener, may be disposed. The balls 717, 718 may be ball bearings or similar structures. According to an embodiment, the balls 717, 718 may be permanently coupled to the clevis 720 in the ball recesses 719 by embossing the sleeve 708 around the balls 717, 718. The balls 717, 718 may partially extend respectively through the bolt recesses 721 in the first and second prong 705, 707 and the driver recess 721.

The driver 710 may include a second end 715 that may include a driving structure 712, such as a ratchet, wrench, or the like, adapted to be coupled to a fastener or other workpiece. Actuating the bit 700 in an axial direction, with respect to the shaft 702, causes the driver 710 to pivot about the balls 717, 718 and provide a torque on the work piece through the driving structure 712. The repeated actuation of the bit 700 by a hammer tool provides repeated applied force to the driver 710 resulting in an applied torque to the work piece.

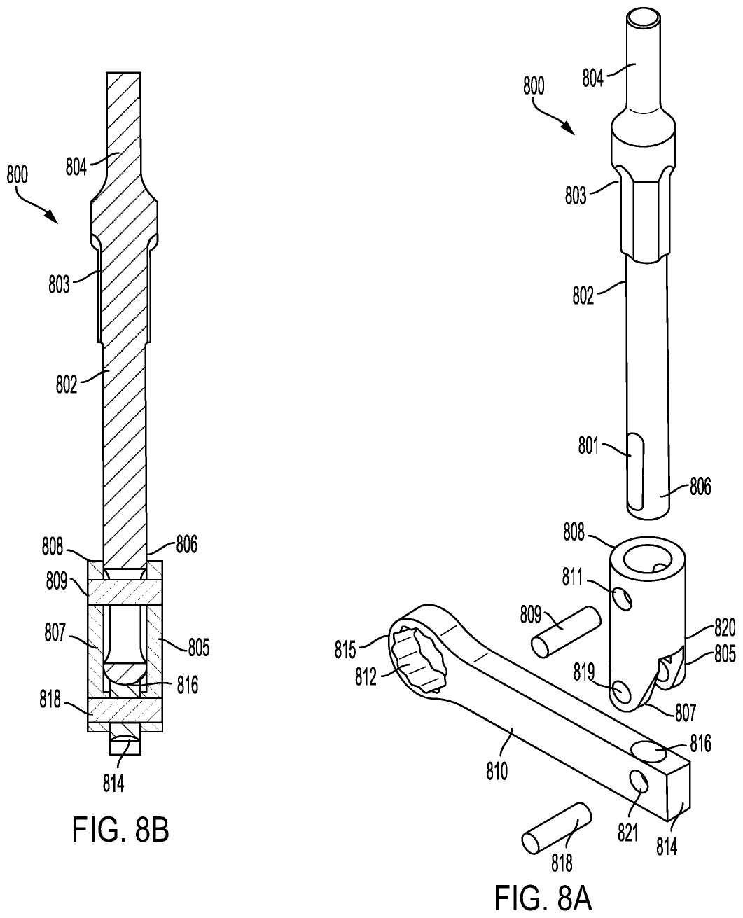

Referring to FIGS. 8A-8B, another embodiment of an air or impact hammer bit tool is depicted. The bit 800 includes a proximal end 804, a distal end 806, and a shank 802 between the ends. The bit 800 may include a non-turning geometry portion 803 adapted to restrict undesired rotation of the bit 800 when engaged with the hammer, similarly to that shown in FIGS. 1A-4B.

According to an embodiment, the distal end 806 may include a groove 801 or slot or other similar structure. A sleeve 808 may be coupled to the distal end 806. The sleeve 808 may include or define a female geometry, such as a clevis 820 or similar structure, to retain a driver 810, including a first prong 805 and a second prong 807. Both the first prong 805 and the second prong 807 may each define a pin recess 819. The sleeve 808 may further define one or more recesses 811. According to an embodiment, the sleeve 808 may be coupled to the distal end 806 by a sleeve pin 809 disposed through the recesses 811 and the groove 801. The sleeve pin 809 may be coupled to the sleeve 808 by press-fit, welding, or other securing mechanism. The pin 809 may be adapted to allow the sleeve 808 to slide axially with respect to the shaft 802 the length of the groove 801.

The clevis 820 may be adapted to couple the driver 810 to the sleeve 808. The clevis 820 may receive a first end 814 of the driver 810. The first end 814 of the driver may include or define a driver recess 821 through which a driver pin 818, or other similar fastener, may be disposed. The driver 810 may include or define a notch 816, divot or other indentation adapted to receive the distal end 806. The driver pin 818 may extend through the pin recesses 819 in the first prong 805, the driver recess 821 and the second prong 807. The driver pin 818 may be secured to the clevis 820 of the sleeve 808 by a nut, or similar fastening method.

The driver 810 may include a second end 815 that may include a driving structure 812, such as a ratchet, wrench, or the like, adapted to be coupled to a fastener or other workpiece. Actuating the bit 800 in an axial direction, with respect to the shaft 802, causes the driver 810 to provide a torque on the work piece through the driving structure 812. The repeated actuation of the bit 800 by a hammer tool provides repeated applied force to the driver 810 resulting in an applied torque to the work piece. According to an embodiment, the driver pin 818 is adapted to rotate freely in the driver recess 821. Accordingly, the sleeve 808 is disposed in the clevis 820 close enough to the first end of the driver 810 such that the bit 800 can rotate about 180-degrees about the driver pin 818. This may allow the bit 800 to impact the first end 814 of the driver 810 without disassembly or removing the driving structure 812 from the workpiece.

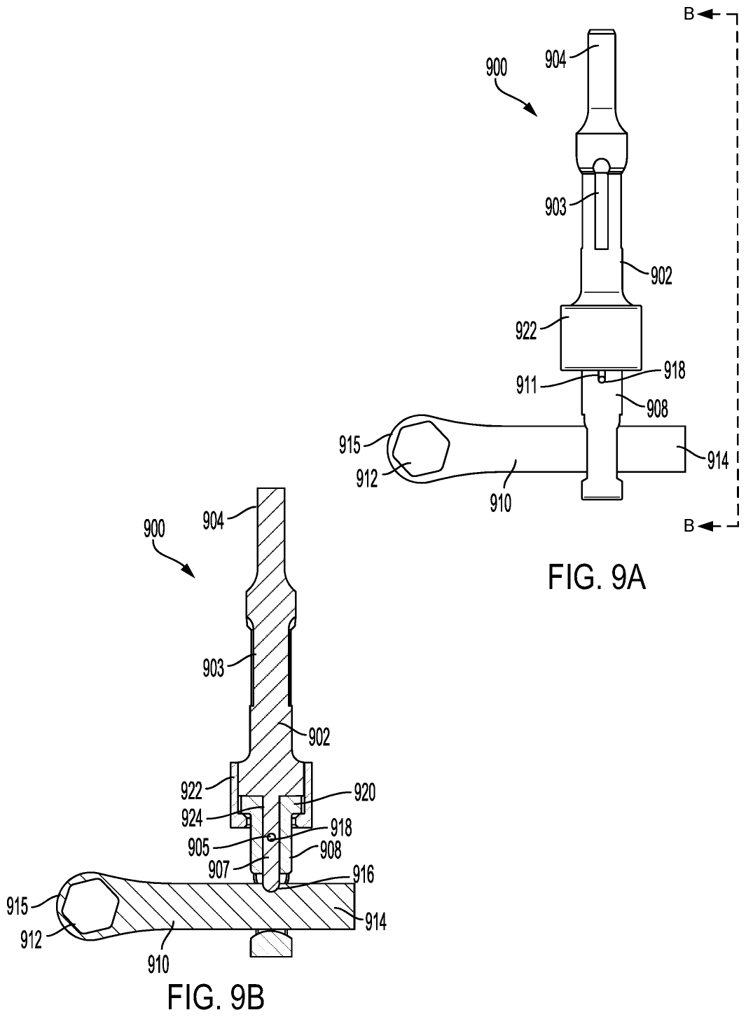

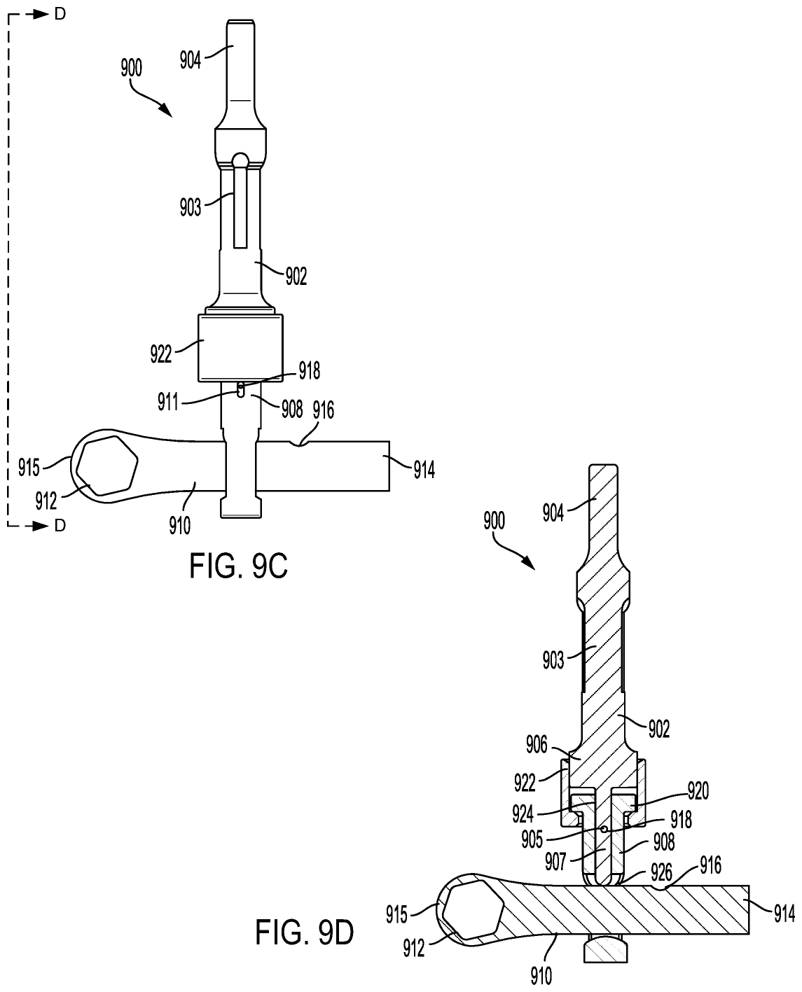

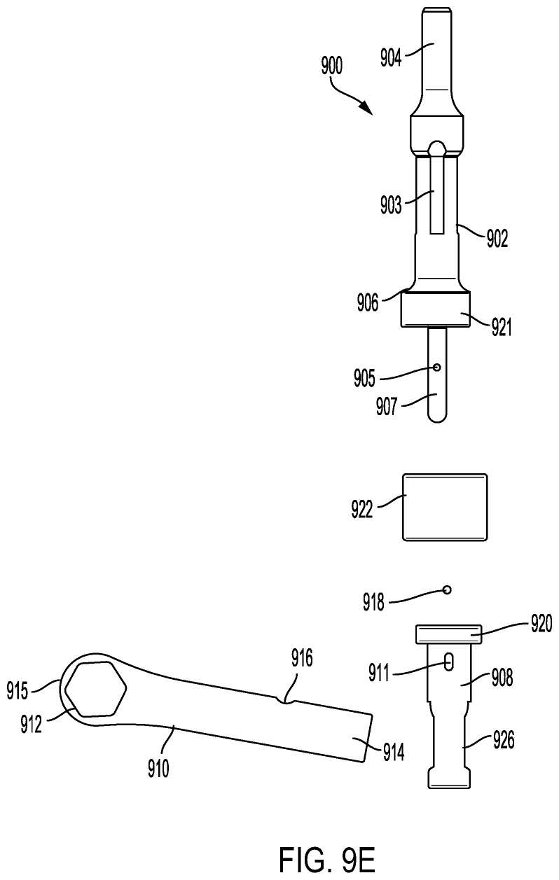

Referring to FIGS. 9A-9E, another embodiment of an air or impact hammer tool bit is depicted. The bit 900 includes a proximal end 904, a distal end 906, and a shank 902 between the ends. The bit 900 may include a non-turning geometry portion 903 adapted to restrict undesired rotation of the bit 900 when engaged with the hammer tool, similarly to that shown in FIGS. 1A-4B.

According to an embodiment, the distal end 906 may include a collar 921 and further include or define a bit tip 907 disposed or formed below the collar 921. The collar may be threaded and adapted to receive a nut 922 having corresponding internal threads. The bit tip 907 may further include or define a pin hole 905. A cradle 908 may include or define a cavity 924 adapted to receive the bit tip 907. The cradle may include or define a shoulder 920 having a wider diameter than the body of the cradle 908. The cradle may further include or define a channel 911 adapted to receive a pin 918. The cradle 908 may be adapted to receive a driver 910 through a female geometry, such as a cradle opening 926.

When assembled, the shoulder 920 of the cradle 908 may be disposed within a lower portion of the inside of the nut 922. The bit tip 907 may engage the cavity 924 of the cradle with the threaded collar 921 engaging the internal threads of the nut 922. The pin 918 may engage the cradle 908 through the channel 911 and the pin hole 905. The bit tip 907 may engage a notch 916, divot or other indentation, formed in a first end 914 of the driver 910. The engagement of the bit tip 907 with the notch 916 secures the driver to the cradle 908.

The driver 910 may include a second end 915 that may include a driving structure 912, such as a ratchet, wrench, or the like, adapted to be coupled to a fastener or other workpiece. Actuating the bit 900 in an axial direction, with respect to the shaft 902, causes the driver 910 to pivot about the bit tip 907 and provide a torque on the work piece through the driving structure 912. The repeated actuation of the bit 900 by a hammer tool provides repeated applied force to the driver 910 resulting in an applied torque to the work piece.

According to an embodiment, the bit 900 allows the driver 910 to rotate about bit 900 and cradle 908 contact points along a design specified arc length. The pin 918, when installed in the pin recess 905 and channel 911, allows the bit 900 to be fully coupled into the driver 910 notch 916 but limits the total amount of opening distance the cradle opening 926 can have. This maximum distance is such that the bit 900 may be allowed operate along any exterior surface of the driver 910, from the driving structure 912 down. This feature allows the user to operate the assembly in many different flexible orientations while also allowing the interchangeability of additional drivers of assorted sizes and configurations.

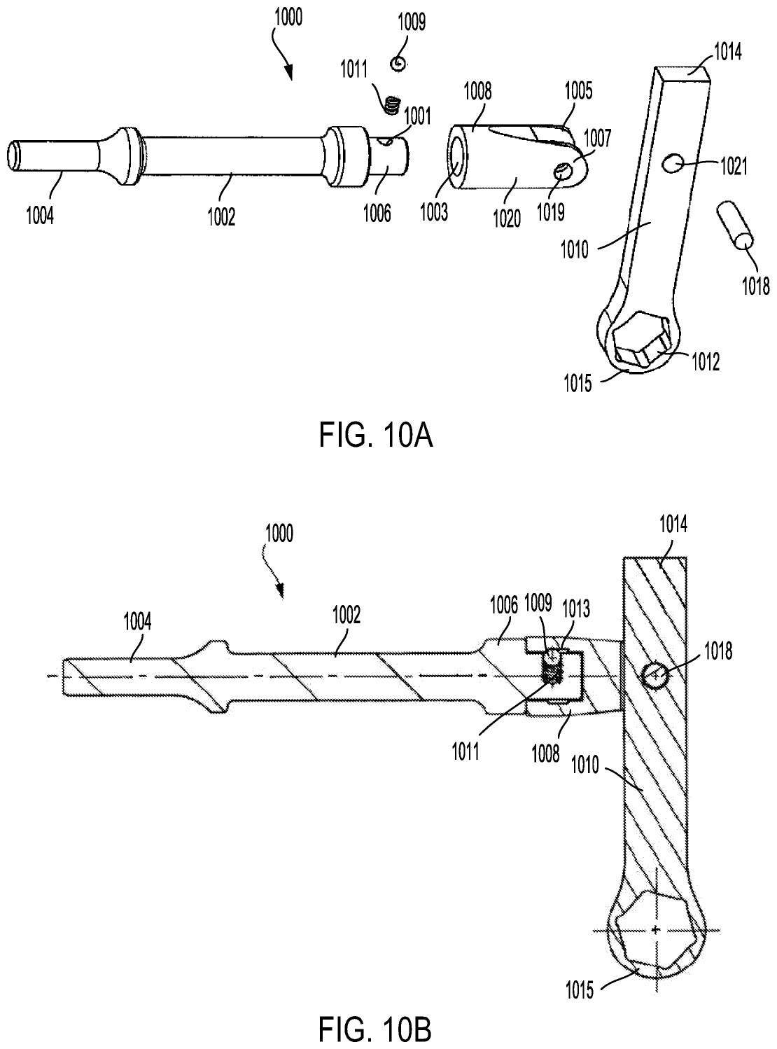

Referring to FIGS. 10A-10B, another embodiment of an air or impact hammer tool bit is depicted. Like the bit depicted in FIGS. 5A-5B, the bit 1000 includes a proximal end 1004, a distal end 1006, and a shank 1002 between the ends. The bit 1000 may include a non-turning geometry portion (not shown) adapted to restrict undesired rotation of the bit 1000 when engaged with the hammer tool, similarly to that shown in FIGS. 4A-4B.

According to an embodiment, the distal end 1006 may include a ball 1009 and spring 1011, substantially disposed in a recess 1001. A sleeve 1008 may be coupled to the distal end 1006. According to an embodiment, the sleeve 1008 may include or define a female geometry, such as a clevis 1020 or similar structure, to retain a driver 1010, including a first prong 1005 and a second prong 1007. Both the first prong 1005 and the second prong 1007 may each define a bolt opening 1019. According to an embodiment, the sleeve 1008 may be coupled to the distal end 1006 by ball 1009 disposed in recess 1001, that engages a groove 1013 disposed in an interior surface 1003 of the sleeve 1008. Additional balls and grooves may be provided The ball 1009 may be ball bearings or similar structures.

The clevis 1020 may be adapted to couple the driver 1010 to the sleeve 1008. The clevis 1020 may receive a first end 1014 of the driver 1010. The first end 1014 of the driver may include or define a driver recess 1021 through which a bolt 1018, or other similar fastener, may be disposed. The bolt 1018 may extend through the bolt recesses 1019 in the first and second prongs 1005, 1007 and the driver recess 1021. The bolt 1018 may be secured to the clevis 1020 of the sleeve 1008 by a nut, or similar fastener. The driver 1010 may pivot about the bolt 1018, as described below. The bit 1000 may impact the driver 1010 on either face, allowing the user to flip the driver 1010 as needed to access a fastener.

The driver 1010 may include a second end 1015 that may include a driving structure 1012, such as a ratchet, wrench, or the like, adapted to be coupled to a fastener or other workpiece. Actuating the bit 1000 in an axial direction, with respect to the shaft 1002, causes the driver 1010 to pivot about the work piece and provide a torque through the driving structure 1012. The repeated actuation of the bit 1000 by a hammer tool provides repeated applied force to the driver 1010 resulting in an applied torque to the work piece.

While the embodiments described herein describe an air hammer bit coupled to a driver or wrench, one skilled in the art will recognize that other drivers and tool geometries, including, for example, 6-point hex, 12-point double hex, open end, flare nut end, spline, external Torx, Philips, male square drive, female square drive, or any others are within the scope of the present disclosure.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object. As used herein, the term “a” or “one” may include one or more items unless specifically stated otherwise.

As used herein terms denoting direction, order, or orientation such as “first,” “second,” “horizontal,” “vertical,” “lateral,” “top,” “bottom,” “left,” “right,” “over,” “under,” “above,” “below,” “front,” back,” or the like, are non-limiting and used herein for ease of explanation. One of skill in the art will recognize the use of these terms as merely descriptive examples that do not limit the placement, orientation, or disposition of the elements described using such terms.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A tool comprising:
a bit having distal and proximal ends, the proximal end is adapted to removably couple to a tool, the distal end defining an opening; and
a driver coupled to the bit through the opening, the driver including a driving structure;
wherein actuating the bit along an axis of the bit applies force to the driving structure.

2. The tool of claim 1, further comprising a non-turning geometry disposed about the bit, the non-turning geometry adapted to restrict rotation of bit when coupled to the tool.

3. The tool of claim 1, wherein the driving structure is a lug.

4. The tool of claim 1, wherein the driving structure is a ratchet.

5. The tool of claim 1, wherein the driving structure is a wrench.

6. The tool of claim 1, wherein the driver further includes a first end, a neck, and a second end, the driver is coupled to the bit at the neck by passing the first end through the opening of the bit, the driving structure is disposed at the second end.

7. The tool of claim 6, wherein the first end is curved about an axis of the driver.

8. The tool of claim 6, wherein the first end includes a first end width greater than the opening and the neck includes a neck width less than the first end width.

9. The tool of claim 6, wherein the neck includes a shoulder, the shoulder and the neck each having a width greater than the opening.

10. The tool of claim 1, wherein the opening is defined by a clevis and a retainer, the clevis defining a recess.

11. The tool of claim 10, wherein the driver defines a driver recess adapted to receive the retainer.

12. The tool of claim 10, wherein the retainer includes a bolt coupled to the clevis with a nut.

13. The tool of claim 10, wherein the retainer includes a pin disposed in the recess of the clevis.

14. The tool of claim 13, wherein the pin defines a projection adapted to retain the pin in the recess of the clevis.

15. The tool of claim 10, wherein the retainer includes a ball disposed in the recess.

16. The tool of claim 1, wherein the distal end includes a sleeve defining the opening.

17. The tool of claim 16, wherein the bit defines a groove along the axis and the sleeve further defines a sleeve recess adapted to receive a sleeve retainer disposed in the recess and the groove.

18. The tool of claim 16, further comprising a collar disposed about the sleeve retainer.

19. The tool of claim 17, wherein the sleeve retainer includes a ball.

20. The tool of claim 17, wherein the sleeve retainer includes a peg.

21. The tool of claim 1, further comprising:
a cradle defining a cavity and the opening;
a bit tip defined at the distal end of the shank, the bit tip disposed in the cavity; and
a nut coupling the shank to the cradle.

22. The tool of claim 21, wherein the driver defines a notch adapted to receive the bit tip.

23. The tool of claim 21, further comprising:
a pin hole defined in the bit tip;
a channel defined in the cradle; and
a pin disposed in the pin channel and pin hole, the pin adapted to restrict rotation of the bit tip in the cradle.

24. A bit for an air hammer or impact hammer tool, the bit comprising:
a shank having distal and proximal ends, the proximal end is adapted to removably couple to the hammer tool, the distal end defining a female or male geometry;
a non-turning geometry disposed about the shank; and
a driver coupled to the female or male geometry of the distal end, the driver including a driving structure;
wherein actuating the shank along an axis of the shank applies force to the driving structure.

25. The bit of claim 24, wherein the female geometry includes a slot, the driver is adapted to couple to the slot by sliding and rotating the driver through the slot.

26. The bit of claim 24, wherein the female geometry includes a clevis and a clevis retainer, the driver is coupled to the clevis retainer.

27. The bit of claim 26, wherein the clevis retainer includes a pin.

28. The bit of claim 26, wherein the clevis retainer includes a ball bearing.

29. The bit of claim 26, wherein the clevis retainer includes a bolt and nut.
